(19) United States
(12) Patent Application Publication
(10) Pub. No.: US 2018/0308079 A1
(43) Pub. Date: Oct. 25, 2018

(54) VENDING MACHINE, METHOD AND DEVICE FOR CONTROLLING THE SAME AND SYSTEM THEREOF

(71) Applicant: HANGZHOU ZONGS INTELLIGENT TECHNOLOGY CO., LTD., Hangzhou City (CN)

(72) Inventors: Zehou ZONG, Hangzhou City (CN); Jianhuan GUO, Hangzhou City (CN)

(21) Appl. No.: 15/645,431

(22) Filed: Jul. 10, 2017

(30) Foreign Application Priority Data
Apr. 21, 2017 (CN) 201710268870.0

(51) Int. Cl. G06Q 20/18; G06K 19/06; G06Q 20/32; G06Q 30/06; G06Q 20/10; G06K 7/14

(52) U.S. Cl. CPC G06Q 20/18; G06K 19/06037; G06K 7/1417; G06Q 30/0643; G06Q 20/102; G06Q 20/3221

(57) ABSTRACT

A vending machine, a method and device for controlling the same and a system is provided. The method includes receiving an access request initiated by a mobile terminal through scanning a QR code attached to a vending machine; providing to the mobile terminal a commodity display interface corresponding to an online supermarket; pushing a payment interface to the mobile terminal to be displayed after determining through the mobile terminal a commodity selected by a user; interfacing, after determining through the mobile terminal the payment mode selected by the user, with a back end of a payment tool corresponding to the selected payment mode, and pushing a payment interface of the payment tool to the mobile terminal for the user to make electronic payment; and sending delivery instruction to the vending machine upon receiving a signal indicative of successful payment, so as to make the vending machine output a corresponding commodity.

### TECHNICAL FIELD

The present invention relates to the technical field of intelligent vending, and particularly to a vending machine, a method and device for controlling the same and a system thereof.

### BACKGROUND ART

A process of purchasing from a vending machine generally includes steps as follows: a customer triggers the vending machine to present a transaction interface by selecting a commodity through a physical key or a touch screen; the customer makes a cash payment, online payment or card payment for it; and after receiving an information instruction indicative of completion of the payment sent from a server, the vending machine activates an inner mechanical transmission device to make the commodity fall down and thus be delivered to the customer.

The existing vending machine includes complex man-machine interaction physical keys, a touch screen, a cash or card payment device and other auxiliary control parts, which increases the complexity, manufacturing cost, failure rate and maintenance cost of the machine, and hinders the development of the whole industry.

With regard to the problem of high cost brought by the transaction modes of the vending machines in the prior art, no effective solution has been put forward so far.

### SUMMARY

In view of this, an object of the present invention is to provide a vending machine, a method and device for controlling the same and a system thereof, which can reduce the cost of the vending machine.

In a first aspect, an embodiment of the present invention provides a method of controlling a vending machine, applicable to a server. The server is in communication connection with the vending machine, and is a QR-code-linked online supermarket provision apparatus with the QR code (two dimensional code) attached to the vending machine. The method includes: receiving an access request initiated by a mobile terminal through scanning the QR code attached to the vending machine; providing to the mobile terminal an online commodity display interface corresponding to the online supermarket, where commodities displayed in the online commodity display interface correspond to commodities actually displayed on the vending machine; pushing a payment interface to the mobile terminal to be displayed after determining through the mobile terminal a commodity selected by a user in the online supermarket, where the payment interface includes at least one payment mode for the user to select; interfacing, after determining through the mobile terminal a payment mode selected by the user, with a back end of a payment tool corresponding to the payment mode, and pushing a payment interface of the payment tool to the mobile terminal for the user to make electronic payment; and sending a delivery instruction to the vending machine upon receiving a signal indicative of successful payment fed back from the payment tool, so as to make the vending machine output a corresponding commodity, where the delivery instruction carries identification information of the commodity selected by the user in the online supermarket.

In combination with the first aspect, an embodiment of the present invention provides a first possible implementation of the first aspect, the step of receiving an access request initiated by a mobile terminal through scanning the QR code attached to the vending machine includes: receiving an access request initiated by the mobile terminal through scanning the QR code attached to the vending machine with the payment tool.

In combination with the first possible implementation of the first aspect, an embodiment of the present invention provides a second possible implementation of the first aspect, the step of pushing a payment interface to the mobile terminal to be displayed includes: acquiring a payment interface of the payment tool by interfacing with the back end of the payment tool; and pushing the payment interface of the payment tool to the mobile terminal to be displayed.

In combination with the first aspect, an embodiment of the present invention provides a third possible implementation of the first aspect, before the step of providing to the mobile terminal an online commodity display interface corresponding to the online supermarket, the method further includes: inquiring commodity arrangement information, price information and commodity quantity corresponding to the QR code; and generating the online commodity display interface according to the commodity arrangement information, the price information and the commodity quantity.

In combination with the third possible implementation of the first aspect, an embodiment of the present invention provides a fourth possible implementation of the first aspect, the step of generating the online commodity display interface according to the commodity arrangement information, the price information and the commodity quantity includes: determining a position of the commodity in the display interface according to the commodity arrangement information; and adding a picture and the price information corresponding to the commodity to the position, to generate the online commodity display interface.

In combination with the third possible implementation of the first aspect, an embodiment of the present invention provides a fifth possible implementation of the first aspect, the method further includes: updating online commodity arrangement information and price information corresponding to the QR code, if types of the commodities displayed on the vending machine are changed; updating online commodity quantity corresponding to the QR code, if a commodity is sold from the vending machine or a commodity is replenished to the vending machine; and sending a reminder message to a staff of the mobile terminal, if the commodity quantity is smaller than a predetermined stock value.

In a second aspect, an embodiment of the present invention further provides a device for controlling a vending machine, which is provided on a server. The server is in communication connection with the vending machine, and is a QR-code-linked online supermarket provision apparatus with the QR code attached to the vending machine. The device includes: a receiving module, configured to receive an access request initiated by a mobile terminal through scanning the QR code attached to the vending machine; a commodity display interface providing module, configured to provide to the mobile terminal an online commodity display interface corresponding to the online supermarket, where commodities displayed in the online commodity display interface correspond to commodities actually displayed on the vending machine; a payment interface pushing module, configured to push a payment interface to the mobile terminal to be displayed after determining through the mobile terminal a commodity selected by a user in the online supermarket, where the payment interface includes at least one payment mode for the user to select; a payment module, configured to interface, after determining through the mobile terminal a payment mode selected by the user, with a back end of a payment tool corresponding to the payment mode, and push a payment interface of the payment tool to the mobile terminal for the user to make electronic payment; and a delivery instruction sending module, configured to send a delivery instruction to the vending machine upon receiving a signal indicative of successful payment fed back from the payment tool, so as to make the vending machine output a corresponding commodity, where the delivery instruction carries identification information of the commodity selected by the user in the online supermarket.

In a third aspect, an embodiment of the present invention further provides a vending machine. The vending machine has only one transaction entry which is an attached QR code, the QR code is linked to an online supermarket provided by a server. The vending machine further includes a signal receiver and a controller. The signal receiver is configured to receive a delivery instruction from the sever, and send the delivery instruction to the controller, where the delivery instruction carries identification information of a commodity selected by a user in the online supermarket. The controller is configured to trigger, after receiving the delivery instruction, a transmission device inside the vending machine to output a commodity corresponding to the identification information.

In combination with the third aspect, an embodiment of the present invention provides a first possible implementation of the third aspect, a housing of the vending machine includes a transparent glass window, a delivery port and a supply gate. Actual information of commodities in the vending machine is determined through the window, the commodity is provided to the user through the delivery port, and the commodities are replenished through the supply gate. The vending machine further includes a lighting lamp receives, when the vending machine is activated, an instruction from the controller to provide lighting to the QR code and all the commodities.

In a fourth aspect, an embodiment of the present invention further provides a vending machine system, including a server and the vending machine provided in the third aspect or one of its possible implementations. The server includes the device for controlling the vending machine provided in the second aspect, and the server is in communication connection with the vending machine.

The embodiments of the present invention offer the following beneficial effects:

The vending machine, the method and device for controlling the same and the system thereof provided by the embodiments are deeply based on the mobile Internet. The user can enter the online supermarket by scanning the QR code, select the commodities in the online supermarket, and make electronic payment through a payment tool. As can be seen, both the selection and payment of the whole commodity transaction process are completed online. The vending machine only needs to be attached with the QR code as the transaction entry, without the need for entitative man-machine interaction physical key configuration, the touch screen, the cash or card payment device or other auxiliary control parts, thereby greatly reducing the cost of the vending machine. Meanwhile, the commodities displayed in the online supermarket completely correspond to the commodities displayed on the vending machine, which enables the user's experiences of “what you see is what you get” and “what you see is what you can get at once”, thereby improving user's satisfaction, and enhancing the operation efficiency.

Other features and advantages of the present invention will be set forth in the following description, and will partially become obvious from the description, or understood by implementing the present invention. The object and other advantages of the present invention are realized and obtained by the structures specified in the description, the claims and the figures.

In order to make the above object, features and advantages of the present invention more obvious and easier to be understand, preferable embodiments are particularly illustrated as below so as to detail the description in conjunction with the accompanying drawings.

### BRIEF DESCRIPTION OF DRAWINGS

In order to illustrate technical solutions of embodiments in the present invention or in the prior art more clearly, the figures required in the description of the embodiments or the prior art will be introduced briefly below. Obviously, the figures in the following description merely show some embodiments of the present invention. A person skilled in the art still can obtain other relevant figures according to these figures, without paying inventive effort.

FIG. 1 is a schematic flow chart of a method for controlling a vending machine provided by an embodiment of the present invention;

FIG. 2 is a structural schematic view of a device for controlling a vending machine provided by an embodiment of the present invention;

FIG. 3 is a structural schematic view of a vending machine provided by an embodiment of the present invention; and

FIG. 4 is a structural schematic view of a vending machine system provided by an embodiment of the present invention.

### DETAILED DESCRIPTION

In order to make the object, technical solutions and advantages of the embodiments of the present invention clearer, below the technical solutions of the present invention will be described clearly and completely in conjunction with the figures. Apparently, some but not all of the embodiments of the present invention are described. Based on the embodiments of the present invention, all the other embodiments, obtained by a person skilled in the art without paying inventive effort, should fall within the scope of protection of the present invention.

At present, a user completes at a vending machine basic transaction steps, such as triggering the vending machine to present a transaction interface and selecting the goods, in a man-machine interaction mode such as through physical keys or an included touch screen. There are several choices for payment: cash payment, online payment, card payments or the like. As for the online payment, it is implemented as follows: the user uses a payment tool such as WeChat and Alipay running on a mobile terminal device such as a cellphone to scan a QR code generated on the included screen of the vending machine, so as to complete the online payment. After receiving an information instruction indicative of payment completion sent from a server, the vending machine activates an inner mechanical transmission device to make the goods fall down and thus be delivered to the user.

The existing vending machine includes complex man-machine interaction physical key configuration, an included touch screen, a cash or card payment device and other auxiliary control parts thereof, which increases the complexity, manufacturing cost, failure rate and maintenance cost of the machine, resulting in a high cost of the machine and hindering the development of the whole industry. In the prior art, the Internet technology is merely used in the payment, and it is not fully utilized to achieve effects of improving consumption experiences and enhancing operation efficiency, and moreover, no digital marketing interaction with the consumer can be realized. In view of this, the embodiments of the present invention provide a vending machine, a method and device for controlling the same and a system thereof, which can reduce the cost of the vending machine.

In order to facilitate understanding the present embodiment, firstly, a method for controlling a vending machine disclosed in the embodiment of the present invention is introduced in detail.

### Embodiment 1

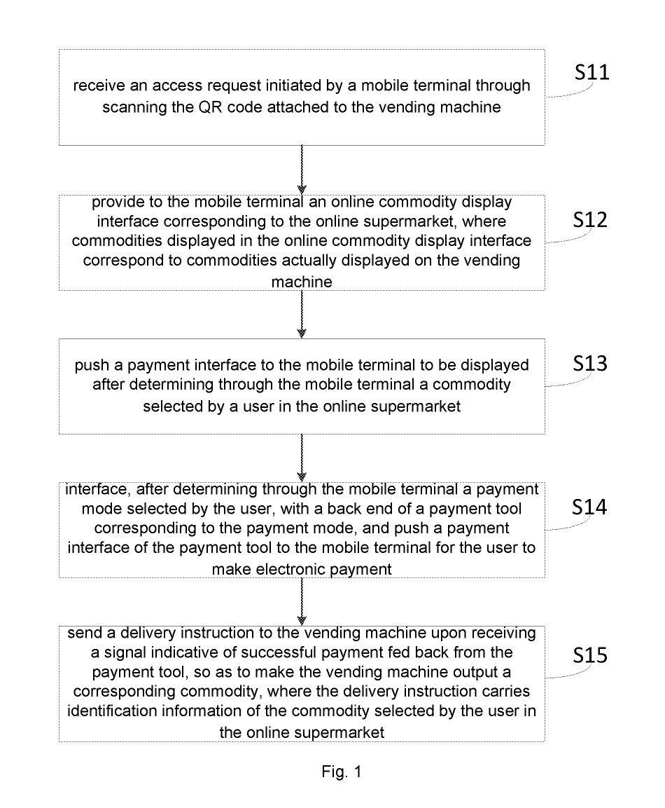

As to the method for controlling a vending machine provided by the embodiment of the present invention, reference may be made to a schematic flow chart of a method for controlling a vending machine as shown in FIG. 1. This method is applicable to a server, the server is in communication connection with the vending machine, and the server is a QR-code-linked online supermarket provision apparatus with the QR code attached to the vending machine, that is, this server is responsible for providing the online supermarket linked to the QR code. The method flow shown by this embodiment includes steps as follows.

In step S11, an access request initiated by a mobile terminal through scanning the QR code attached to the vending machine is received.

The QR code is attached to a body of the vending machine. This QR code has been linked to the online supermarket in advance, and the user can initiate, when purchasing, an access by scanning the QR code with a mobile terminal. It can be understood that this QR code further includes ID information of the vending machine. The mobile terminal includes, but not limited to, mobile electronic devices such as intelligent cellphone and tablet computer. It should be emphasized herein that a transaction entry of the vending machine merely includes the QR code, and other devices for selecting commodities or making transactions are not provided.

Specifically, the user's operation of scanning the QR code with a mobile terminal may be performed with an APP (Application) installed on the mobile terminal, including an APP dedicated to scanning QR codes, a browser provided with a function of scanning QR codes (e.g., a UC browser), or a payment tool provided with a function of scanning QR codes (e.g., WeChat and Alipay).

In step S12, an online commodity display interface corresponding to the online supermarket is provided to the mobile terminal, where commodities displayed in the online commodity display interface correspond to commodities actually displayed on the vending machine.

After receiving the access request sent by the user through scanning the QR code with the mobile terminal, the server sends to the mobile terminal the commodity display interface corresponding to the online supermarket to be displayed on the mobile terminal. In order to ensure the user's consumption experiences of “what you see is what you get” and “what you see is what you can get at once”, the commodities displayed in the sent commodity display interface correspond to the commodities displayed on the vending machine, that is, the commodities displayed in the commodity display interface of the online supermarket and the commodities actually displayed on the vending machine fully correspond to each other in terms of putting positions and price information, alternatively, vertical and horizontal arrangement directions of the commodities are different, while the positions and price information are the same. After entering the online supermarket, the user may select the commodities according to guidance provided by the online supermarket and observation of the commodities in the physical machine before him/her, in combination with personal willingness.

In step S13, after determining through the mobile terminal a commodity selected by the user in the online supermarket, a payment interface is pushed to the mobile terminal to be displayed. The payment interface includes at least one payment mode for the user to select.

After the user selects the commodity from the commodity display interface of the online supermarket displayed on the mobile terminal, the mobile terminal sends a commodity selection signal to the server, to determine the type and quantity of the commodity selected by the user; and then, the payment interface is pushed to the mobile terminal to be displayed. As mentioned above, there are a plurality of APPs capable of scanning QR codes. For example, in the case that the user uses an APP dedicated to scanning the QR codes, it is required to push the payment interface to the mobile terminal to be displayed, where the payment interface includes at least one payment mode for the user to select. For embodiment, in the case that the user uses a payment tool provided with a function of scanning QR codes, the pushing the payment interface to the mobile terminal to be displayed specifically includes the following steps:

1. the server acquires the payment interface of the payment tool by interfacing with a back end of the payment tool, specifically, the server sorts user sources through an entry tool scanning the QR code (i.e., the above payment tool), and acquires the payment interface of the payment tool by interfacing with the back end of the payment tool; and

2. the payment interface of the payment tool is pushed to the mobile terminal to be displayed, specifically, after receiving the payment interface pushed thereto, the mobile terminal jumps to the payment interface for the user to make electronic payment.

In step S14, after determining through the mobile terminal the payment mode selected by the user, the server interfaces with a back end of a payment tool corresponding to the payment mode, and the payment interface of the payment tool is pushed to the mobile terminal for the user to make electronic payment.

For the case that the user uses an APP dedicated to scanning QR codes, the user selects one from the available payment modes, and the server interfaces with the back end of the payment tool corresponding to the selected payment mode, and pushes the payment interface of the payment tool to the mobile terminal for the user to make electronic payment. After the user completes the electronic payment on the payment interface, the payment tool feeds back a signal indicative of successful payment to the server.

In step S15, upon receiving the signal indicative of successful payment fed back from the payment tool, a delivery instruction is sent to the vending machine so as to make the vending machine output a corresponding commodity, where the delivery instruction carries identification information of the commodity selected by the user in the online supermarket.

Upon receiving the signal indicative of successful payment, the server remotely sends an instruction to the vending machine corresponding to the QR code, via a data transmission link including but not limited to 3G, to make the vending machine rotate a coil spring so as to make the commodity fall down and thus be delivered to the user.

Before the step of providing to the mobile terminal an online commodity display interface corresponding to the online supermarket, the method further includes a step of generating an online commodity display interface, which is as follows:

1. commodity arrangement information, price information and commodity quantity corresponding to the QR code are inquired; and 2. the online commodity display interface is generated according to the commodity arrangement information, the price information and the commodity quantity. Specifically, Step 2 includes: determining a position of the commodity in the display interface according to the commodity arrangement information; and adding a picture and the price information corresponding to the commodity to the position to generate the online commodity display interface.

Since each QR code corresponds to a specific vending machine, and types, prices, arrangement positions and quantities of the commodities in each vending machine are different or vary over time, the commodity arrangement information, price information and commodity quantity need to be inquired firstly, and then the commodity display interface is generated according to these information.

The method for controlling the vending machine provided by the present embodiment is deeply based on the mobile Internet. The user can enter the online supermarket by scanning the QR code, select the commodities in the online supermarket, and make electronic payment through a payment tool. As can be seen, both the selection and payment of the whole commodity transaction process are completed online. The vending machine only needs to be attached with the QR code as the transaction entry, without the need for entitative man-machine interaction physical key configuration, the touch screen, the cash or card payment device or other auxiliary control parts, thereby greatly reducing the cost of the vending machine. Meanwhile, the commodities displayed in the online supermarket completely correspond to the commodities displayed on the vending machine, which enables the user's experiences of “what you see is what you get” and “what you see is what you can get at once”, thereby improving user's satisfaction, and enhancing the operation efficiency.

Considering that the types, prices, putting positions and quantities of the commodities in the vending machine may be changed, the method further includes the following steps: updating the commodity arrangement information and the price information corresponding to the QR code, if types of the commodities displayed on the vending machine are changed; updating the commodity quantity corresponding to the QR code, if a commodity is sold from the vending machine or a commodity is replenished to the vending machine; and sending a reminder message to a staff of the mobile terminal, if the commodity quantity is smaller than a predetermined stock value.

Through the above updating operations, the server can precisely store various information of the commodities in the vending machine, so as to generate a precise commodity display interface corresponding to the commodities displayed on the vending machine, and improve user's purchasing experiences.

In order to realize online digital marketing interaction with the consumers, after the payment is completed, a questionnaire may be further sent to the mobile terminal, transaction recommendation information may be further sent according to the identification information of the commodity, or the user terminal may be further guided to other transaction scenes according to the transaction characteristics of the consumers.

### Embodiment 2

An embodiment of the present invention provides a device for controlling a vending machine, which is provided on a server. The server is in communication connection with the vending machine, and is a QR-code-linked online supermarket provision apparatus with the QR code attached to the vending machine.

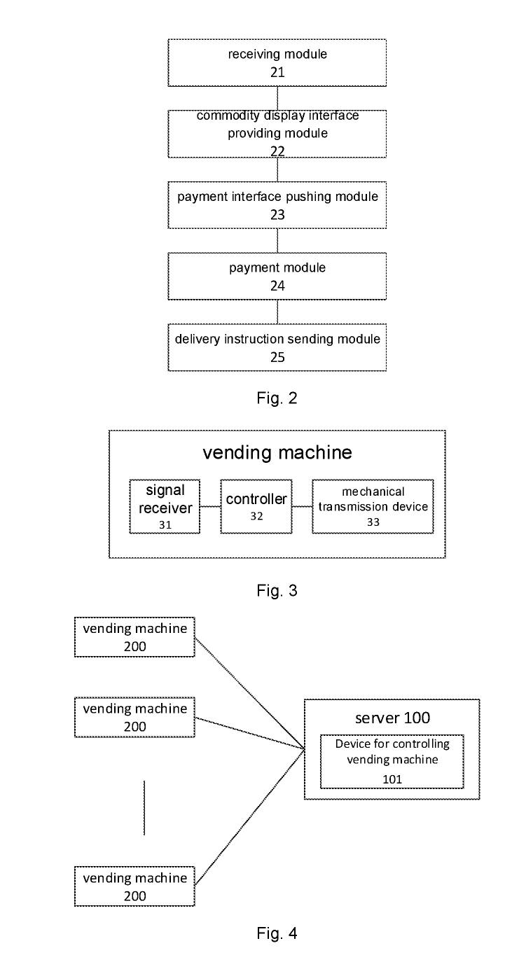

As shown in FIG. 2, the device for controlling a vending machine includes a receiving module 21, a commodity display interface providing module 22, a payment interface pushing module 23, a payment module 24 and a delivery instruction sending module 25. Functions of the above modules are as follows.

The receiving module 21 is configured to receive an access request initiated by a mobile terminal through scanning a QR code attached to the vending machine.

The commodity display interface providing module 22 is configured to provide to the mobile terminal an online commodity display interface corresponding to the online supermarket, where commodities displayed in the online commodity display interface correspond to commodities actually displayed on the vending machine.

The payment interface pushing module 23 is configured to push a payment interface to the mobile terminal to be displayed after determining through the mobile terminal a commodity selected by a user in the online supermarket, where the payment interface includes at least one payment mode for the user to select.

The payment module 24 is configured to interface, after determining through the mobile terminal the payment mode selected by the user, with a back end of a payment tool corresponding to the payment mode, and push a payment interface of the payment tool to the mobile terminal for the user to make electronic payment.

The delivery instruction sending module 25 is configured to send a delivery instruction to the vending machine upon receiving a signal indicative of successful payment fed back from the payment tool, so as to make the vending machine output a corresponding commodity, where the delivery instruction carries identification information of the commodity selected by the user in the online supermarket.

A person skilled in the art can clearly know that for the sake of convenience and simplicity of description, reference may be made to a corresponding process in the preceding method embodiment for a specific operating process of the device for controlling the vending machine as described above, which will not be repeated herein.

### Embodiment 3

An embodiment of the present invention provides a vending machine. The vending machine has only one transaction entry which is an attached QR code, and the QR code is linked to an online supermarket provided by a server. A user selects and pays for a commodity by scanning the QR code.

The vending machine needs to receive a delivery instruction sent by the server. As shown in FIG. 3, the vending machine includes a signal receiver 31, a controller 32 and a mechanical transmission device 33. The signal receiver 31 is configured to receive the delivery instruction from the sever, and send the delivery instruction to the controller 32, where the delivery instruction carries identification information of a commodity selected by the user in the online supermarket. The controller 32 is configured to trigger, after receiving the delivery instruction, the mechanical transmission device 33 inside the vending machine to output the commodity corresponding to the identification information. Both the selection the commodities and the payment of the whole transaction process are completed online, and the vending machine merely acts only as an entitative delivery apparatus, which offers the last delivery of the whole transaction process.

Specifically, a housing of the vending machine includes a transparent glass window, a delivery port and a supply gate. Actual information of commodities in the vending machine is determined through the window, the commodity is provided to the user through the delivery port, and the commodities are replenished through the supply gate.

It should be emphasized herein that the vending machine is merely attached with one QR code as the transaction entry, and this QR code also includes ID information of the vending machine; moreover, only this QR code acts as the transaction entry, and there is no need for entitative man-machine interaction physical key configuration, a touch screen, a cash or card payment device or other auxiliary control parts. With the above QR code, multiple types of payment are enabled; and despite of the type of the payment tool, the transaction may be entered by scanning this QR code.

Furthermore, the vending machine further includes a lighting lamp, where this lighting lamp is connected with the controller. When the vending machine is activated, the lighting lamp receives an instruction from the controller to provide lighting to the QR code and all the commodities. Since most of the vending machines are installed indoors, preferably, the lighting lamp is controlled to provide lighting when the vending machine is activated.

The vending machine provided by the present embodiment is attached with the QR code as the transaction entry, without the need for the entitative man-machine interaction physical key configuration, the touch screen, the cash or card payment device or the other auxiliary control parts, thereby greatly reducing the cost of the vending machine.

### Embodiment 4

An embodiment of the present invention provides a vending machine system. As shown in FIG. 4, the vending machine system includes a server 100 and the vending machine 200 provided in Embodiment 3. The server includes the device 101 for controlling the vending machine provided in Embodiment 2, and the server is in communication connection with the vending machine. It can be understood that the server 100 may be in communication connection with multiple vending machines 200.

The vending machine is attached with a QR code, and the QR code is linked to an online supermarket provided by the server, and the QR code also includes ID information of the vending machine.

The vending machine system provided in the embodiment of the present invention has same technical features as those of the vending machine and the device for controlling the vending machine provided in the above embodiments, and therefore, it can also solve the same technical problems and achieve the same technical effects.

A computer program product of the vending machine, the method and device for controlling the same and the system thereof provided in the embodiments of the present invention includes a computer readable storage medium storing program codes, and instructions included in the program codes can be used to execute the method in the preceding method embodiment. Reference may be made to the method embodiments for specific implementation, which will not be repeated herein.

Besides, in the description of the embodiments of the present invention, it also should be indicated that unless otherwise specified and defined, terms “instal”, “link” and “connect” should be understood widely. For example, it may be a fixed connection, a detachable connection, or an integrated connection; it may be a mechanical connection, or an electrical connection; it may be a direct connection, or an indirect connection through an intermediate medium; and it also may be an inner communication between two elements. For a person skilled in the art, the specific meanings of the terms as mentioned above in the present invention can be understood in specific situations.

If the above functions are realized in the form of software functional unit and are sold or used as an individual product, they may be stored in one computer readable storage medium. Based on such understanding, the technical solution of the present invention essentially, or a part thereof contributing to the prior art or a part of this technical solution may be embodied in the form of a software product, and this computer software product is stored in one storage medium, and includes several instructions used to cause one computer device (which may be a personal computer, a sever or a network device etc.) to execute all or part of the steps of the methods provided by various embodiments of the present invention. The aforementioned storage medium includes various media that can store program codes, such as U disk, mobile hard disk, Read-Only Memory (ROM), Random Access Memory (RAM), diskette or compact disk.

In the description of the present invention, it should be noted that the orientational or positional relationships indicated by terms such as “center”, “upper”, “lower”, “left”, “right”, “vertical”, “horizontal”, “inner” and “outer” are based on the orientational or positional relationships as shown in the figures, merely for facilitating describing the present invention and simplifying the description, rather than indicating or suggesting that related devices or elements have to be in a specific orientation, or configured and operated in a specific orientation, and therefore, they should not be construed as limiting the present invention. Besides, terms such as “first”, “second” and “third” are merely for descriptive purpose, but should not be understood as indicating or suggesting the presence of a relative importance.

Finally, it is to be explained that the above-mentioned embodiments are merely implementations of the present invention, and they are used to illustrate the technical solutions of the present invention, rather than limiting the invention. The scope of protection of the present invention is not limited thereto.

While the detailed description is made to the present invention with reference to the aforementioned embodiments, those skilled in the art should understand that, within the technical scope disclosed in the present invention, any person skilled in the art can still modify or easily make change to the technical solutions recited in the aforementioned embodiments, or make equivalent substitution to some of the technical features therein; however, these modifications, changes or substitutions do not make corresponding technical solutions essentially depart from the spirit and scope of the technical solutions of the present invention, and all of them should fall into the scope of protection of the present invention. Therefore, the scope of protection of the present invention should be determined by the scope of protection of the claims.

1. A method for controlling a vending machine, applicable to a server, wherein the server is in communication connection with the vending machine, and is a QR-code-linked online supermarket provision apparatus with the QR-code attached to the vending machine, the method comprising:
receiving an access request initiated by a mobile terminal through scanning the QR code attached to the vending machine;
providing to the mobile terminal an online commodity display interface corresponding to the online supermarket, wherein commodities displayed in the online commodity display interface correspond to commodities actually displayed on the vending machine;
pushing a payment interface to the mobile terminal to be displayed, after determining through the mobile terminal a commodity selected by a user in the online supermarket, wherein the payment interface comprises at least one payment mode for the user to select;
interfacing, after determining through the mobile terminal a payment mode selected by the user, with a back end of a payment tool corresponding to the payment mode, and pushing a payment interface of the payment tool to the mobile terminal for the user to make electronic payment; and
sending a delivery instruction to the vending machine upon receiving a signal indicative of successful payment fed back from the payment tool, so as to make the vending machine output a corresponding commodity,
wherein the delivery instruction carries identification information of the commodity selected by the user in the online supermarket.

2. The method according to claim 1, wherein the receiving an access request initiated by a mobile terminal through scanning the QR code attached to the vending machine comprises:
receiving an access request initiated by the mobile terminal through scanning the QR code attached to the vending machine with the payment tool.

3. The method according to claim 2, wherein the pushing a payment interface to the mobile terminal to be displayed comprises:
acquiring a payment interface of the payment tool by interfacing with the back end of the payment tool; and
pushing the payment interface of the payment tool to the mobile terminal to be displayed.

4. The method according to claim 1, wherein before the providing to the mobile terminal an online commodity display interface corresponding to the online supermarket, the method further comprises:
inquiring commodity arrangement information, price information and commodity quantity corresponding to the QR code; and
generating the online commodity display interface according to the commodity arrangement information, the price information and the commodity quantity.

5. The method according to claim 4, wherein the generating the online commodity display interface according to the commodity arrangement information, the price information and the commodity quantity comprises:
determining a position of the commodity in the display interface according to the commodity arrangement information; and
adding a picture and the price information corresponding to the commodity to the position, to generate the online commodity display interface.

6. The method according to claim 4, further comprising:
updating online commodity arrangement information and price information corresponding to the QR code, if types of the commodities displayed on the vending machine are changed;
updating online commodity quantity corresponding to the QR code, if a commodity is sold from the vending machine or a commodity is replenished to the vending machine; and
sending a reminder message to a staff of the mobile terminal, if the commodity quantity is smaller than a predetermined stock value.

7. A device for controlling a vending machine, the device provided on a server, wherein the server is in communication with the vending machine, and is an QR-code-linked online supermarket provision apparatus with the QR code attached to the vending machine, the device comprising:
a receiving module, configured to receive an access request initiated by a mobile terminal through scanning the QR code attached to the vending machine;
a commodity display interface providing module, configured to provide to the mobile terminal an online commodity display interface corresponding to the online supermarket, wherein commodities displayed in the online commodity display interface correspond to commodities actually displayed on the vending machine;
a payment interface pushing module, configured to push a payment interface to the mobile terminal to be displayed, after determining through the mobile terminal a commodity selected by a user in the online supermarket, wherein the payment interface comprises at least one payment mode for the user to select;
a payment module, configured to interface, after determining through the mobile terminal a payment mode selected by the user, with a back end of a payment tool corresponding to the payment mode, and push a payment interface of the payment tool to the mobile terminal for the user to make electronic payment; and
a delivery instruction sending module, configured to send a delivery instruction to the vending machine upon receiving a signal indicative of successful payment fed back from the payment tool, so as to make the vending machine output a corresponding commodity, wherein the delivery instruction carries identification information of the commodity selected by the user in the online supermarket.

8. The device according to claim 7, wherein the receiving module is further configured to receive the access request initiated by the mobile terminal through scanning the QR code attached to the vending machine with the payment tool.

9. The device according to claim 8, wherein the payment interface pushing module is further configured to:
acquire a payment interface of the payment tool by interfacing with the back end of the payment tool; and
push the payment interface of the payment tool to the mobile terminal to be displayed.

10. The device according to claim 7, wherein the commodity display interface providing module is further configured to:
determine a position of the commodity in the display interface according to the commodity arrangement information; and
add a picture and the price information corresponding to the commodity to the position, to generate the online commodity display interface.

11. A vending machine, wherein the vending machine has only one transaction entry which is an attached QR code, the QR code is linked to an online supermarket provided by a server, and the vending machine further comprises a signal receiver and a controller;
wherein the signal receiver is configured to receive a delivery instruction from the sever, and send the delivery instruction to the controller, wherein the delivery instruction carries identification information of a commodity selected by a user in the online supermarket; and
wherein the controller is configured to trigger, after receiving the delivery instruction, a transmission device inside the vending machine to output a commodity corresponding to the identification information.

12. The vending machine according to claim 11, wherein a housing of the vending machine comprises a transparent glass window, a delivery port and a supply gate, actual information of commodities in the vending machine is determined through the window, the commodity is provided to the user through the delivery port, and the commodities are replenished through the supply gate;
wherein the vending machine further comprises a lighting lamp, wherein the lighting lamp is connected with the controller; and
wherein the lighting lamp receives, when the vending machine is activated, an instruction from the controller to provide lighting to the QR code and all the commodities.
